(19) United States
(12) Patent Application Publication
(10) Pub. No.: US 2022/0164670 A1
(43) Pub. Date: May 26, 2022

(54) Training Method for Convolutional Neural Network and System

(71) Applicant: Robert Bosch GmbH, Stuttgart (DE)

(72) Inventors: Hao Sun, Shanghai (CN); Yu Gao, Shanghai (CN); Ze Cheng, Shanghai (CN)

(21) Appl. No.: 17/455,075

(22) Filed: Nov. 16, 2021

(30) Foreign Application Priority Data
Nov. 17, 2020 (CN) 20 2011 289 535.7

(51) Int. Cl. G06N 3/08; G06N 3/10

(52) U.S. Cl. CPC G06N 3/084; G06N 3/10

(57) ABSTRACT

A computer-implemented training method for a convolutional neural network includes receiving first data and second data. The second data is data obtained after stylization is performed on the first data. The method further includes training the convolutional neural network based on the first data and the second data. The convolutional neural network has a first normalization layer and a second normalization layer. The first normalization layer is used for the first data, and the second normalization layer is used for the second data. The convolutional neural network trained in this way is no longer biased towards texture, and not only enhances robustness but also improves accuracy.

This application claims priority under 35 U.S.C. § 119 to patent application no. CN 20 2011 289 535.7, filed on Nov. 17, 2020 in China, the disclosure of which is incorporated herein by reference in its entirety.

The disclosure relates to the field of artificial intelligence, and in particular, to training and application of a convolutional neural network.

### BACKGROUND

In the field of artificial intelligence, a convolutional neural network has been extensively applied to image classification and image detection. Generally, using a convolutional neural network to learn features of a plurality of samples facilitates object classification and detection based on an image. The features learned may include a shape feature or a texture feature. In recent research, it is preferred to train, based on an image texture feature, a convolutional neural network for object classification and detection.

On this basis, to further improve robustness of a trained machine learning model, adversarial examples are used in a training process. However, this may reduce accuracy of the machine learning model. Some studies have shown that a trade-off is needed between robustness and accuracy of a machine learning model.

### SUMMARY

An improved training method for a convolutional neural network is provided, which is biased towards learning a shape feature of a sample, and can improve robustness and accuracy of a machine learning model.

It has been realized that in current research, it is preferred to train, based on an image texture feature, a convolutional neural network for object classification and detection, and a shape feature is neglected. However, in actual cases, both a shape feature and a texture feature shall be considered to recognize an object, and it is obviously unreasonable to neglect a shape feature.

According to various embodiments in various aspects of the disclosure, a convolutional neural network is trained based on first data and second data that is obtained after stylization is performed on the first data. The stylization is performed on the first data, to make an object less characterized by a texture feature of the object, but to retain characterization of the object by a shape feature. Model training based on such features focuses more on a shape feature of a training sample and is no longer biased towards texture as in current research. In this way, the trained convolutional neural network has a first normalization layer and a second normalization layer that are respectively used for performing normalization on the first data and the second data that is obtained after the stylization is performed. This takes into consideration different distribution of the first data and the second data that is obtained after the stylization is performed, and the convolutional neural network designed therefrom focuses more on a shape feature and is no longer biased towards texture, and not only enhances robustness but also improves accuracy.

According to an aspect, a computer-implemented training method for a convolutional neural network is provided, the method including: receiving first data and second data, where the second data is data obtained after stylization is performed on the first data; and training the convolutional neural network based on the first data and the second data, where the convolutional neural network has a first normalization layer and a second normalization layer, the first normalization layer is used for the first data, and the second normalization layer is used for the second data.

According to another aspect, a computer-implemented method for detecting an object is provided, the method including: receiving data of the object; and detecting the object based on the data of the object by using the convolutional neural network trained using the training method according to various embodiments of the disclosure.

According to another aspect, a computer system is provided, including one or more processors; and one or more storage devices storing computer-executable instructions, where the instructions, when executed by the one or more processors, cause the one or more processors to perform the method according to various embodiments of the disclosure.

According to another aspect, a computer program product is provided, storing computer-executable instructions, where the instructions, when run, cause a computer or a processor to perform the method according to various embodiments of the disclosure.

According to still another aspect, a machine-readable medium is provided, storing computer-executable instructions, where the instructions, when run, cause a computer or a processor to perform the method according to various embodiments of the disclosure.

### BRIEF DESCRIPTION OF THE DRAWINGS

In the drawings, embodiments are described only by way of example rather than limitation. Similar reference numerals in the drawings refer to similar elements.

FIG. 1 shows a part of an architecture of a convolutional neural network according to an embodiment of the disclosure;

FIG. 2 shows a computer-implemented training method for a convolutional neural network according to an embodiment of the disclosure;

FIG. 3 shows a computer-implemented method for detecting an object according to an embodiment of the disclosure; and

FIG. 4 is schematic diagram of a computer system according to an embodiment of the disclosure.

Various aspects and features of various embodiments of the disclosure are described with reference to the above drawings. The above drawings are only schematic rather than limiting. Without departing from the essence of the disclosure, the dimensions, shape, reference numeral, or appearance of each element in the above drawings may be changed. In addition, earphones or various parts of a device in the embodiments of the disclosure are not fully marked with reference numerals in the above drawings. In some drawings, only related parts are shown, but this does not limit various parts to those shown in the drawings of this specification.

### DETAILED DESCRIPTION

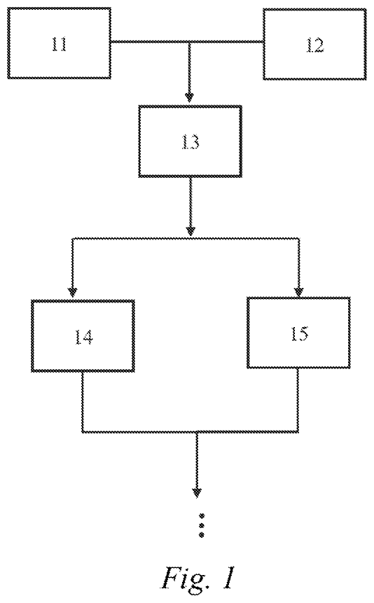

FIG. 1 shows a part of an architecture of a convolutional neural network according to an embodiment of the disclosure.

As shown in FIG. 1, the convolutional neural network includes a convolution layer 13, a first normalization layer 14, and a second normalization layer 15. First data 11 and second data 12 are input to the convolution layer 13 as training samples. The second data 12 is data obtained after stylization is performed on the first data 11. The first data and the second data may include image data, audio data, or text data.

In a training process, the first data 11 and the second data 12 are labeled to distinguish the first data 11 and the second data 12. When the first data 11 is input to the convolution layer 13, a feature map output from the convolution layer 13 is input to the first normalization layer 14 for normalization. When the second data 12 is input to the convolution layer 13, a feature map output from the convolution layer 13 is input to the second normalization layer 15 for normalization. Therefore, the normalization layers 14 and 15 are configured for the first data 11 and the second data 12 respectively.

The first and second normalization layers may use any appropriate algorithm for performing normalization correspondingly which includes batch normalization, group normalization, and/or the like. In an embodiment, the first and second normalization layers are both batch normalization layers.

Normalization is performed on each of the first data 11 and the second data 12 obtained after stylization is performed, and this takes into consideration different distribution of the two types of data, so that different normalization is used. In this way, this focuses more on a shape feature and is no longer biased towards texture, and also improves robustness and accuracy of a machine learning model.

In an embodiment, in a process of training the convolutional neural network, the first data 11 and the corresponding second data 12 are separately input, and after the first data 11 and the second data 12 are processed by using the first normalization layer 14 and the second normalization layer 15 respectively, a first loss and a second loss are calculated respectively for the first data 11 and the second data 12 based on a usual loss function loss(x). Then, the first loss and the second loss may be weighted, to calculate a total loss. For example, the total loss may be a weighted sum of the first loss and the second loss. For example, the total loss is equal to w*loss(A)+(1−w)*loss(sA), where A is the first data 11, sA is the second data 12, and w is a weight. The total loss is used for performing backpropagation.

In another embodiment, in a process of training the convolutional neural network, a loss corresponding to input data may be determined based on a label of the input data, to perform backpropagation. For example, in the training process, if the first data 11 is input, a loss corresponding to the first data is determined based on a loss function corresponding to the first data 11, that is, w*loss(A), and then the determined loss is directly used for performing backpropagation. However, if the second data 12 is input, a loss corresponding to the second data is determined based on a loss function corresponding to the second data 12, that is, (1−w)*loss(sA), and then the determined loss is used for performing backpropagation.

Although the convolutional neural network is described with reference to only the first data, the second data, the corresponding first normalization layer, and the corresponding second normalization layer, it is also conceivable that the convolutional neural network may be designed to be used for data of more types and accordingly include more normalization layers.

For example, the convolutional neural network may be deigned to receive third data in the training process, where the third data is also data that is obtained after stylization is performed on the first data, but is obtained after stylization different from that for the second data. For example, the second data is obtained after stylization is performed on the first data, and the third data is obtained after another stylization is performed on the first data, where the stylization is different from the another stylization. The two processes may relate to different styles, or use different processing algorithms.

For the third data, the convolutional neural network may include a third normalization layer. When the third data is input, a corresponding feature map is input to the third normalization layer for normalization. When there is the third data, a weight for calculating a loss may be set for each of the first data, the second data, and the third data.

In the part of the convolutional neural network shown in FIG. 1, only a part important for describing this embodiment of the disclosure is shown, which is not limiting, and the convolutional neural network further includes other parts not shown. In addition, the part of the convolutional neural network shown in FIG. 1 may be configured for each convolution layer in the entire convolutional neural network, or may be configured for each module when the convolutional neural network includes a plurality of modules. This is not limiting as well.

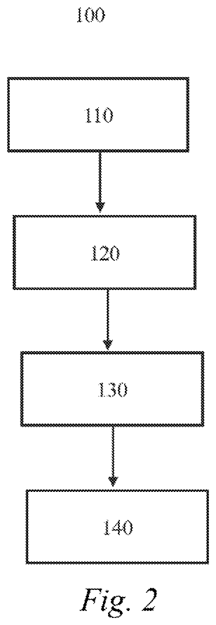

FIG. 2 shows a computer-implemented training method 100 for the convolutional neural network according to an embodiment of the disclosure.

According to the method 100, in step 110, first data is received. The first data includes image data, audio data, or text data. In step 120, stylization is performed on the first data, to obtain second data. In step 130, the convolutional neural network is trained based on the first data and the second data. When the first data is input for training the convolutional neural network, a first normalization layer is used for normalization, and when the second data is input for training the convolutional neural network, a second normalization layer is used for normalization. The first and second normalization layers are different normalization layers.

As described above, it is conceivable that the convolutional neural network is further designed to receive third data for training. In this case, when the third data is input, a third normalization layer is used for normalization. The first, second, and third normalization layers may each be a batch normalization layer.

In step 140, a loss is calculated for performing backpropagation. In an embodiment, a corresponding first loss and a corresponding second loss is calculated for the first data and the second data respectively, and then the corresponding first loss or the corresponding second loss is used for backpropagation. For example, when the first data is input, the first loss can be determined correspondingly, and the first loss is weighted, to perform backpropagation; when the second data is input, the second loss can be determined correspondingly, and the second loss is weighted, to perform backpropagation.

In another embodiment, if the first data and the second data are sequentially input as a group to the convolutional neural network for training, the first loss for the first data and the second loss for the second data can be determined respectively, and then the first loss and the second loss are weighted. A total loss is determined based on the weighted first and second losses, to perform backpropagation.

The above merely describes a part of the training method for the convolutional neural network with reference to the method 100, which is not limiting, and other training steps, if necessary, are further included. A machine learning model obtained after training the convolutional neural network can be used for object detection, including object recognition, image classification, semantic segmentation, instance segmentation, and the like.

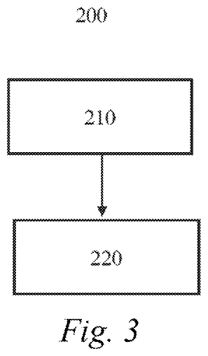

FIG. 3 shows a computer-implemented method 200 for detecting an object according to an embodiment of the disclosure.

According to the method 200, in step 210, data of the object is received, where the data includes image data, audio data, or text data, and the data of the object is used as an input to a convolutional neural network obtained after training. In step 220, the object is detected based on the data of the object by using the trained convolutional neural network, which includes object classification, recognition, and the like based on an image. When the trained convolutional neural network is used, the data of the object is input to a first normalization layer corresponding to first data for processing.

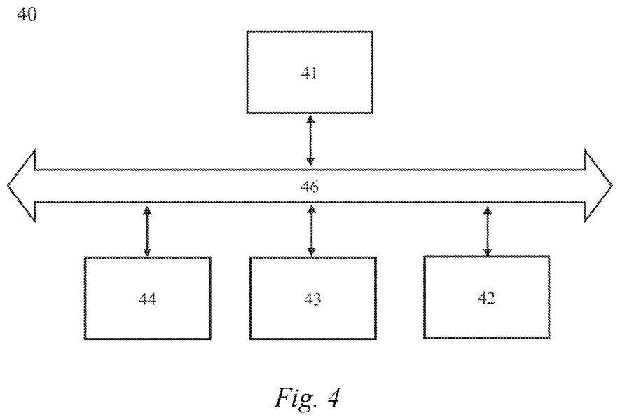

FIG. 4 is schematic diagram of a computer system 40 according to an embodiment of the disclosure. As shown in FIG. 4, the computer system 40 may include at least one processor 41, a memory (for example, a nonvolatile memory) 42, an internal memory 43, and a communication interface 44, and the at least one processor 41, the memory 42, the internal memory 43, and the communication interface 44 are connected to each other via a bus 46. The at least one processor 41 executes at least one computer-readable instruction (namely, the above element implemented in a form of software) stored or encoded in the memory.

In an embodiment, computer-executable instructions are stored in the memory, and the instructions, when executed, cause the at least one processor 41 to perform the various operations and functions described above in various embodiments of the disclosure in conjunction with FIGS. 2 and 3.

According to an embodiment, a computer program product such as a machine-readable medium (for example, a non-transitory machine-readable medium) is provided. The machine-readable medium may have instructions (namely, the above elements implemented in a form of software) that, when executed by a machine, cause the machine to perform various operations and functions described above in various embodiments of the disclosure in conjunction with FIGS. 2 and 3. Specifically, a system or an apparatus with a readable storage medium may be provided, and software program code for implementing the functions of any embodiment described above is stored on the readable storage medium, and a computer or a processor of the system or apparatus is caused to read and execute the instructions stored in the readable storage medium.

The exemplary embodiments of the disclosure cover both of the following: Computer programs/software of the disclosure are/is created/used from the beginning, and existing programs/software are/is converted to use the computer programs/software of the disclosure by means of updating.

The computer programs for performing the method according to the various embodiments of the disclosure may alternatively be published in another form, for example, via the Internet or other wired or wireless telecommunication systems.

The computer programs may alternatively be provided on a network such as the World Wide Web, and can be downloaded from such a network to a working computer of a microprocessor.

It must be pointed out that the embodiments of the disclosure are described with reference to different subjects. In particular, some embodiments are described with reference to method-type claims, while other embodiments are described with reference to device-type claims. However, those skilled in the art will learn from the above and following descriptions that, unless otherwise specified, in addition to any combination of features belonging to one type of subject, any combination of features related to different subjects is also deemed to be disclosed by the application. Moreover, all the features can be combined to provide a synergistic effect that is greater than the simple addition of the features.

Specific embodiments of the disclosure have been described above. Other embodiments are within the scope of the appended claims. In some cases, actions or steps described in the claims may be performed in an order different from that in the embodiments and desired results can still be achieved. In addition, the processes described in the accompanying drawings do not necessarily require the specific order or sequential order shown to achieve the desired results. In some embodiments, multitasking and parallel processing are also possible or may be advantageous.

The disclosure is described above with reference to specific embodiments. Those skilled in the art should understand that the technical solutions of the disclosure can be implemented in various ways without departing from the spirit and basic features of the disclosure. Specific embodiments are only schematic rather than limiting. In addition, these embodiments can be combined arbitrarily to achieve the purpose of the disclosure. The scope of protection of the disclosure is defined by the appended claims.

The word “include/comprise” in the specification and claims does not exclude the existence of other elements or steps, and terms such as “first”, “second”, and “step” and an order of the various steps shown in the figures limit neither a sequence nor the number. The function of each element described in this specification or in the claims can alternatively be divided or combined, and implemented by a plurality of corresponding elements or a single element.

What is claimed is:

1. A computer-implemented training method for a convolutional neural network, comprising:
receiving first data;
performing a first stylization on the received first data;
receiving second data after the first stylization is performed on the first data; and
training the convolutional neural network based on the first data and the second data,
wherein the convolutional neural network has a first normalization layer used for the first data, and
wherein the convolutional neural network has a second normalization layer used for the second data.

2. The training method according to claim 1, further comprising:
receiving third data after a second stylization is performed on the first data, the second stylization different from the first stylization; and
training the convolutional neural network based on the third data,
wherein the convolutional neural network further has a third normalization layer used for the third data.

3. The training method according to claim 1, wherein the first data comprises at least one of image data, audio data, and text data.

4. The training method according to claim 1, wherein:
the first normalization layer comprises a first batch normalization layer; and/or
the second normalization layer comprises a second batch normalization layer.

5. The training method according to claim 1, further comprising:
calculating a first loss for the first data;
weighting the calculated first loss; and
performing backpropagation based on the weighted first loss.

6. The training method according to claim 5, further comprising:
calculating a second loss for the second data;
weighting the calculated second loss; and
performing backpropagation based on the weighted second loss.

7. The training method according to claim 6, further comprising:
determining a total loss based on the weighted first loss and the weighted second loss; and
performing backpropagation based on the determined total loss.

8. A computer-implemented method for detecting an object, comprising:
receiving data of the object; and
detecting the object based on the received data of the object using a convolutional neural network,
wherein the convolutional neural network is trained by (i) receiving first data, (ii) performing a first stylization on the received first data, (iii) receiving second data after the first stylization is performed on the first data, and (iv) training the convolutional neural network based on the first data and the second data,
wherein the convolutional neural network has a first normalization layer used for the first data, and
wherein the convolutional neural network has a second normalization layer used for the second data.

9. The method according to claim 8, further comprising:
inputting the data of the object to the first normalization layer.

10. A computer system, comprising:
one or more processors; and
one or more storage devices storing computer-executable instructions,
wherein the computer-executable instructions, when executed by the one or more processors, cause the one or more processors to perform a method for detecting an object including (i) receiving data of the object, and (ii) detecting the object based on the received data of the object using a convolutional neural network,
wherein the convolutional neural network is trained by (i) receiving first data, (ii) performing a first stylization on the received first data, (iii) receiving second data after the first stylization is performed on the first data, and (iv) training the convolutional neural network based on the first data and the second data,
wherein the convolutional neural network has a first normalization layer used for the first data, and
wherein the convolutional neural network has a second normalization layer used for the second data.

11. The computer system according to claim 10, wherein the computer-executable instructions are included in a computer program product.

12. The computer system according to claim 11, wherein the computer program product is stored on a non-transitory computer-readable medium.
